(19) United States
(12) Patent Application Publication
(10) Pub. No.: US 2016/0288784 A1
(43) Pub. Date: Oct. 6, 2016

(54) HYBRID VEHICLE, CONTROL DEVICE FOR HYBRID VEHICLE, AND CONTROL METHOD FOR HYBRID VEHICLE WITH CONTROLLER FOR MANAGING THE OUTPUT OF A BATTERY IN CASE OF ENGINE DECOMPRESSION SITUATION

(71) Applicant: TOYOTA JIDOSHA KABUSHIKI KAISHA, Toyota-shi (JP)

(72) Inventors: Ryuta TERAYA, Okazaki-shi (JP); Toshikazu KATO, Toyota-shi (JP); Yoshikazu ASAMI, Gotenba-shi (JP)

(73) Assignee: TOYOTA JIDOSHA KABUSHIKI KAISHA, Toyota-shi (JP)

(21) Appl. No.: 15/038,139

(22) PCT Filed: Nov. 20, 2014
(86) PCT No.: PCT/IB2014/002524

§ 371 Date: May 20, 2016

(30) Foreign Application Priority Data
Dec. 3, 2013 (JP) 2013-250212

(51) Int. Cl. B60W 20/40; B60W 10/06; B60W 20/20; B60K 6/26; B60W 20/13; B60W 30/192; B60K 6/442; B60W 10/26; B60W 30/182

(52) U.S. Cl. CPC B60W 20/40; B60W 10/26; B60W 10/06; B60W 20/20; B60W 30/182; B60W 20/13; B60W 30/192; B60K 6/442; B60K 6/26; B60W 2510/244; B60W 2710/244; Y10S 903/93; Y10S 903/905; B60K 2006/268; B60Y 2200/92; B60Y 2300/182; B60Y 2300/192; B60Y 2300/437; B60Y 2300/63; B60Y 2300/91

(57) ABSTRACT

The hybrid vehicle includes an internal combustion engine, an electric motor, an electrical storage device and a controller. The controller is configured to control an output from the electrical storage device on the basis of a state of the electrical storage device such that the output from the electrical storage device at the time when start-up of the internal combustion engine is required in a predetermined condition in a state where the operation characteristic is set to the second characteristic is higher than the output from the electrical storage device, which is set on the basis of the state of the electrical storage device at the time when start-up of the internal combustion engine is required. The predetermined condition is a condition in which startability of the internal combustion engine deteriorates.

### BACKGROUND OF THE INVENTION

1. Field of the Invention

The invention relates to a hybrid vehicle, a control device for a hybrid vehicle, and a control method for a hybrid vehicle and, more particularly, to a hybrid vehicle that includes an internal combustion engine including a variable valve actuating device for changing the operation characteristic of an intake valve, a control device for the hybrid vehicle, and a control method for the hybrid vehicle.

2. Description of Related Art

There is known an internal combustion engine including a variable valve actuating device that is able to change the operation characteristic of an intake valve. There is also known a variable valve actuating device that is able to change at least one of the valve lift or valve operating angle of an intake valve as such a variable valve actuating device (see Japanese Patent Application Publication No. 2005-299594 (JP 2005-299594 A), Japanese Patent Application Publication No. 2009-167885 (JP 2009-167885 A), Japanese Patent Application Publication No. 2009-202662 (JP 2009-202662 A), Japanese Patent Application Publication No. 2004-183610 (JP 2004-183610 A), Japanese Patent Application Publication No. 2013-53610 (JP 2013-53610 A), Japanese Patent Application Publication No. 2008-25550 (JP 2008-25550 A), Japanese Patent Application Publication No. 2012-117376 (JP 2012-117376 A), Japanese Patent Application Publication No. 9-242519 (JP 9-242519 A), and the like).

For example, JP 2005-299594 A describes a variable valve actuating device that is able to change the valve lift and valve operating angle of each intake valve of an engine. In this variable valve actuating device, when the engine is automatically stopped on the assumption that the engine is restarted in a relatively short time, the valve operating angle of each intake valve during engine stop is set to a maximum operating angle in order to fully obtain decompression. In contrast, when the engine is manually stopped, a target valve operating angle during engine stop is set to a value smaller than that when the engine is automatically stopped in order to handle both high-temperature start-up and low-temperature start-up, thus giving a higher priority to startability of the engine (see JP 2005-299594 A).

### SUMMARY OF THE INVENTION

In a hybrid vehicle in which a driving electric motor is mounted in addition to an engine, start-up and stop of the engine are automatically controlled on the basis of a traveling state. Therefore, the process of starting up the engine frequently occurs. Particularly, the inside of a vehicle cabin is quiet while the hybrid vehicle is travelling by using only the electric motor. Therefore, vibrations and noise resulting from start-up of the engine are easily experienced by a user. Thus, the technique described in JP 2005-299594 A is useful for a hybrid vehicle in terms of suppressing vibrations at start-up of an engine.

In control over the characteristic of each intake valve according to JP 2005-299594 A, when the engine is automatically stopped, the valve operating angle of each intake valve during engine stop is uniformly set to a maximum valve operating angle so that decompression is fully obtained. However, when the valve operating angle (or valve lift) of each intake valve is increased, part of air taken into a cylinder in an intake stroke is returned to the outside of the cylinder, so ignitability deteriorates as a result of a reduction in compression ratio, so the output response of the engine decreases. Therefore, if there occurs a situation that cranking torque is not sufficiently obtained at engine start-up, there is a concern that the startability of the engine deteriorates.

The invention is to suppress vibrations at start-up of an internal combustion engine and to ensure startability of the internal combustion engine in a hybrid vehicle including the internal combustion engine having a variable valve actuating device for changing the operation characteristic of an intake valve.

An aspect of the invention provides a hybrid vehicle. The hybrid vehicle includes an internal combustion engine, an electric motor, an electrical storage device and a controller. The internal combustion engine includes a variable valve actuating device. The variable valve actuating device is configured to change an operation characteristic of an intake valve to one of a first characteristic and a second characteristic: At least one of a valve lift or valve operating angle of the intake valve at the time when the operation characteristic is the second characteristic is larger than the corresponding at least one of the valve lift or valve operating angle of the intake valve at the time when the operation characteristic is the first characteristic. The electric motor is configured to be used to start up the internal combustion engine. The electrical storage device is configured to store electric power for driving the electric motor. The controller is configured to control an output from the electrical storage device on the basis of a state of the electrical storage device such that the output from the electrical storage device at the time when start-up of the internal combustion engine is required in a predetermined condition in a state where the operation characteristic is set to the second characteristic is higher than the output from the electrical storage device, which is set on the basis of the state of the electrical storage device at the time when start-up of the internal combustion engine is required. The predetermined condition is a condition in which startability of the internal combustion engine deteriorates.

With the above hybrid vehicle, when start-up of the internal combustion engine is required in the predetermined condition in which startability of the internal combustion engine deteriorates, even when the operation characteristic of the intake valve is the second characteristic, the output from the electrical storage device is set so as to be higher than the output that is set on the basis of the state of the electrical storage device at the time when start-up of the internal combustion engine is required. By controlling the output from the electrical storage device in this way, it is possible to increase cranking torque that is applied to the internal combustion engine by the electric motor at start-up of the internal combustion engine. Thus, with the above hybrid vehicle, it is possible to suppress vibrations at start-up of the internal combustion engine and to ensure startability of the internal combustion engine.

The phrase “when start-up of the internal combustion engine is required” includes not only when start-up of the internal combustion engine is actually required but also at the time when a process of stopping the internal combustion engine is executed just before start-up of the internal combustion engine is carried out.

In the above aspect, the controller may be configured to control the output from the electrical storage device such that the output from the electrical storage device decreases as an SOC of the electrical storage device decreases. The controller may be configured to control the SOC such that the SOC is higher than a control lower limit of the SOC. The controller may be configured to, when the predetermined condition is satisfied in the state where the operation characteristic is set to the second characteristic at the time when a process of stopping the internal combustion engine is executed, increase the SOC of the electrical storage device by increasing the control lower limit such that the output from the electrical storage device is higher than the output from the electrical storage device, which is set on the basis of the SOC at the time when the predetermined condition is satisfied. The controller may be configured to stop the internal combustion engine after the SOC is increased to above the control lower limit.

With the above hybrid vehicle, the SOC is increased by increasing the control lower limit of the SOC at the time when the process of stopping the internal combustion engine is executed. Thus, the output from the electrical storage device is increased at restart of the internal combustion engine. In this way, it is possible to increase cranking torque that is applied to the internal combustion engine by the electric motor.

In the above aspect, the controller may be configured to limit the output from the electrical storage device on the basis of a decrease in a temperature of the electrical storage device. The controller may be configured to, when the internal combustion engine is in a cold state in the state where the operation characteristic is set to the second characteristic and when start-up of the internal combustion engine is required, set a discharge power upper limit value of the electrical storage device such that the discharge power upper limit value is higher than the discharge power upper limit value that is set on the basis of the temperature of the electrical storage device at the time when start-up of the internal combustion engine is required.

With the above hybrid vehicle, by increasing the discharge power upper limit value of the electrical storage device, it is possible to increase cranking torque that is applied to the internal combustion engine by the electric motor.

In the above aspect, the controller may be configured to, at the time when a process of starting up the internal combustion engine is executed, execute a process of increasing the discharge power upper limit value.

With the above hybrid vehicle, it is possible to suppress advance of degradation of the electrical storage device resulting from an unnecessary increase in discharge power of the electrical storage device.

In the above aspect, the controller may be configured to, when the variable valve actuating device is inoperable in the state where the operation characteristic is set to the second characteristic, execute a process of increasing the output from the electrical storage device.

With the above hybrid vehicle, even when the operation characteristic of the intake valve becomes unchangeable from the second characteristic and startability of the internal combustion engine cannot be improved by changing the operation characteristic of the intake valve to the first characteristic, it is possible to increase cranking torque that is applied to the internal combustion engine by the electric motor. Thus, it is possible to ensure startability of the internal combustion engine.

In the above aspect, the variable valve actuating device may be configured to change the operation characteristic to one of the first characteristic and the second characteristic stepwisely.

In the above aspect, the variable valve actuating device may be configured to change the operation characteristic to a third characteristic. At least one of the valve lift or the valve operating angle at the time when the operation characteristic is the third characteristic may be larger than the corresponding at least one of the valve lift or the valve operating angle at the time when the operation characteristic is the first characteristic, and at least one of the valve lift or the valve operating angle at the time when the operation characteristic is the third characteristic may be smaller than the corresponding at least one of the valve lift or the valve operating angle at the time when the operation characteristic is the second characteristic.

With the above hybrid vehicles, the operation characteristic of the intake valve is configured to be changed stepwisely, so it is possible to reduce a time that is required to adapt control parameters for controlling the operating state of the internal combustion engine. In addition, it is possible to reduce torque that is required of the actuator for changing the operation characteristic of the intake valve, so it is possible to reduce the size and weight of the actuator. The manufacturing cost of the actuator can also be reduced.

Another aspect of the invention provides a control device for a hybrid vehicle. The hybrid vehicle includes an internal combustion engine, an electric motor and an electrical storage device. The internal combustion engine includes a variable valve actuating device. The electric motor is configured to be used to start up the internal combustion engine. The electrical storage device is configured to store electric power for driving the electric motor. The control device includes a controller. The controller is configured to control the variable valve actuating device such that an operation characteristic of an intake valve is changed to one of a first characteristic and a second characteristic. At least one of a valve lift or valve operating angle of the intake valve at the time when the operation characteristic is the second characteristic is larger than the corresponding at least one of the valve lift or valve operating angle of the intake valve at the time when the operation characteristic is the first characteristic. The controller is configured to control an output from the electrical storage device on the basis of a state of the electrical storage device such that the output from the electrical storage device at the time when start-up of the internal combustion engine is required in a predetermined condition in a state where the operation characteristic is set to the second characteristic is higher than the output from the electrical storage device, which is set on the basis of the state of the electrical storage device at the time when start-up of the internal combustion engine is required. The predetermined condition is a condition in which startability of the internal combustion engine deteriorates.

Further another aspect of the invention provides a control method for a hybrid vehicle. The hybrid vehicle includes an internal combustion engine, an electric motor, an electrical storage device and a controller. The internal combustion engine includes a variable valve actuating device. The electric motor is configured to be used to start up the internal combustion engine. The electrical storage device is configured to store electric power for driving the electric motor. The control method includes: controlling the variable valve actuating device and controlling an output from the electrical storage device. The variable valve actuating device is controlled by the controller such that an operation characteristic of an intake valve is changed to one of a first characteristic and a second characteristic. At least one of a valve lift or valve operating angle of the intake valve at the time when the operation characteristic is the second characteristic is larger than the corresponding at least one of the valve lift or valve operating angle of the intake valve at the time when the operation characteristic is the first characteristic. An output from the electrical storage device is controlled by the controller on the basis of a state of the electrical storage device such that the output from the electrical storage device at the time when start-up of the internal combustion engine is required in a predetermined condition in a state where the operation characteristic is set to the second characteristic is higher than the output from the electrical storage device, which is set on the basis of the state of the electrical storage device at the time when start-up of the internal combustion engine is required. The predetermined condition is a condition in which startability of the internal combustion engine deteriorates.

According to the invention, it is possible to suppress vibrations at start-up of an internal combustion engine and to ensure startability of the internal combustion engine in a hybrid vehicle including the internal combustion engine having a variable valve actuating device for changing the operation characteristic of an intake valve.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a block diagram that shows the overall configuration of a hybrid vehicle according to a first embodiment of the invention;

FIG. 2 is a configuration view of an engine shown in FIG. 1;

FIG. 3 is a graph that shows the correlation between a crank angle and a valve displacement that is achieved by a VVL device;

FIG. 4 is a front view of the VVL device;

FIG. 5 is a perspective view that partially shows the VVL device shown in FIG. 4;

FIG. 6 is a view that illustrates an operation at the time when the valve lift and valve operating angle of each intake valve are large;

FIG. 7 is a view that illustrates an operation at the time when the valve lift and valve operating angle of each intake valve are small;

FIG. 8 is a transition diagram that illustrates intermittent operation control over the engine in the hybrid vehicle shown in FIG. 1;

FIG. 9 is a time chart that shows an example of intermittent operation of the engine;

FIG. 10 is a graph that shows the correlation between the temperature of an electrical storage device and a discharge power upper limit value;

FIG. 11 is a graph that shows the correlation between the SOC of the electrical storage device and a discharge power upper limit value;

FIG. 12 is a graph that shows the correlation between the degree of degradation of the electrical storage device and a discharge power upper limit value;

FIG. 13 is a flowchart that illustrates the control structure of intake valve control in the hybrid vehicle according to the first embodiment;

FIG. 14 is a flowchart that illustrates the control structure of intake valve control in the hybrid vehicle according to a second embodiment;

FIG. 15 is a graph that shows the correlation between a crank angle and a valve displacement that is achieved by a VVL device that is able to change the operation characteristic of each intake valve in three steps;

FIG. 16 is a graph that shows an operating line of an engine including the VVL device having the operation characteristics shown in FIG. 15;

FIG. 17 is a flowchart that illustrates the control structure of intake valve control according to the first embodiment by applying the VVL device having the operation characteristics shown in FIG. 15;

FIG. 18 is a flowchart that illustrates the control structure of intake valve control according to the second embodiment by applying the VVL device having the operation characteristics shown in FIG. 15; and

FIG. 19 is a graph that shows the correlation between a crank angle and a valve displacement that is achieved by a VVL device that is able to change the operation characteristic of each intake valve in two steps.

### DETAILED DESCRIPTION OF EMBODIMENTS

Hereinafter, embodiments of the invention will be described in detail with reference to the accompanying drawings. The plurality of embodiments will be described below; however, appropriate combinations of the configurations described in the embodiments are expected at the time of filing. Like reference numerals denote the same or corresponding portions in the drawings, and the description thereof will riot be repeated.

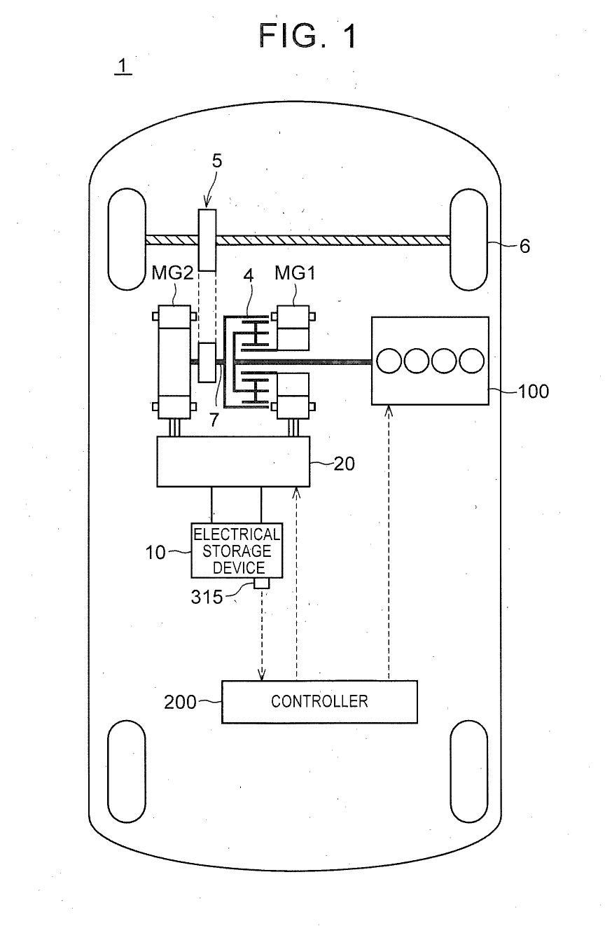

FIG. 1 is a block diagram that shows the overall configuration of a hybrid vehicle according to the first embodiment of the invention. As shown in FIG. 1, the hybrid vehicle 1 includes an engine 100, motor generators MG1, MG2, a power split device 4, a reduction gear 5, and drive wheels 6. The hybrid vehicle 1 further includes an electrical storage device 10, a power control unit (PCU) 20 and a controller 200.

The hybrid vehicle 1 is able to travel by using driving force that is output from at least one of the engine 100 or the motor generator MG2. The engine 100 is, for example, an internal combustion engine, such as a gasoline engine and a diesel engine. The engine 100 generates driving force for propelling the vehicle. The engine 100 also generates driving force for driving the motor generator MG1 that is able to operate as a generator. The engine 100 can be cranked by the motor generator MG1 to start up. The engine 100 includes a variable valve actuating device for changing the operation characteristic of each intake valve. The variable valve actuating device is controlled by the controller 200 on the basis of a traveling condition of the vehicle and startability of the engine 100. The configuration of the engine 100 and variable valve actuating device will be described in detail later.

The power split device 4 is configured to be able to split driving force, which is generated by the engine 100, into driving force for driving the drive wheels 6 via an output shaft 7 and the reduction gear 5 and driving force for driving the motor generator MG1. The power split device 4 is formed of, for example, a planetary gear train.

Each of the motor generators MG1, MG2 is an alternating-current rotary electric machine, and is, for example, a three-phase alternating-current synchronous motor generator. The motor generator MG1 can generate electric power by using the driving force of the engine 100. The driving force of the engine 100 is received via the power split device 4. For example, when the SOC of the electrical storage device 10 reaches a predetermined lower limit, the engine 100 starts up, and electric power is generated by the motor generator MG1. Electric power generated by the motor generator MG1 is converted in voltage by the PCU 20. The converted electric power is temporarily stored in the electrical storage device 10, or the converted electric power is directly supplied to the motor generator MG2.

The motor generator MG2 generates driving force by using at least one of electric power stored in the electrical storage device 10 or electric power generated by the motor generator MG1. Driving force of the motor generator MG2 is transmitted to the drive wheels 6 via the output shaft 7 and the reduction gear 5. In FIG. 1, the drive wheels 6 are front wheels. Instead of the front wheels or in addition to the front wheels, rear wheels may be driven by the motor generator MG2.

During braking of the vehicle, the motor generator MG2 is driven by the drive wheels 6 via the reduction gear 5, and the motor generator MG2 operates as a generator. Thus, the motor generator MG2 operates as a regenerative brake that converts braking energy to electric power. Electric power generated by the motor generator MG2 is stored in the electrical storage device 10.

The PCU 20 is a drive unit for driving the motor generators MG1, MG2. The PCU 20 includes an inverter for driving the motor generators MG1, MG2, and can further include a converter for converting voltage between the inverter and the electrical storage device 10.

The electrical storage device 10 is a rechargeable direct-current power supply, and includes, for example, a nickel-metal hydride secondary battery or a lithium ion secondary battery. The voltage of the electrical storage device 10 is, for example, about 200 V. The electrical storage device 10 stores electric power generated by the motor generators MG1, MG2. A large-capacitance capacitor may also be employed as the electrical storage device 10. The electrical storage device 10 may be any electric power buffer as long as the electric power buffer is able to temporarily store electric power generated by the motor generators MG1, MG2 and supply the stored electric power to the motor generator MG2. A sensor 315 is provided at the electrical storage device 10. The sensor 315 is used to detect the temperature Tb, current Ib and voltage Vb of the electrical storage device 10. Values detected by the sensor 315 are output to the controller 200.

The controller 200 includes an electronic control unit (ECU) that includes a central processing unit (CPU), a storage device, input/output buffers, and the like (which are not shown). The controller 200 receives signals from various sensors and outputs control signals to devices, and executes control over the devices in the hybrid vehicle 1. As an example, the controller 200 executes traveling control over the hybrid vehicle 1, charging control (SOC control) over the electrical storage device 10, control over the engine 100 including the variable valve actuating device, and .the like. The configuration of the controller 200 will be described later.

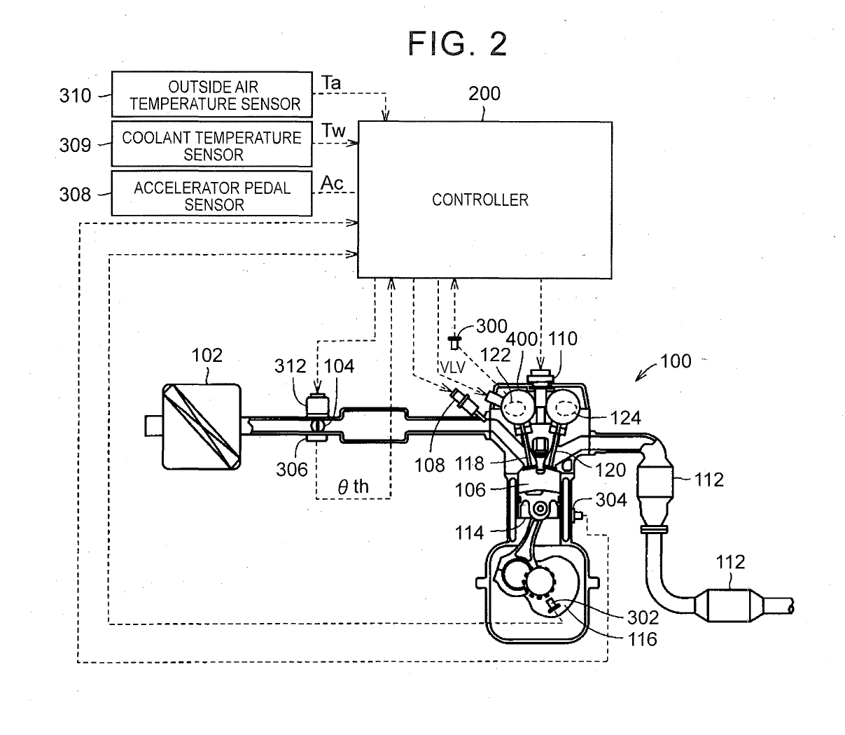

FIG. 2 is a configuration view of the engine 100 shown in FIG. 1. As shown in FIG. 2, air is taken into the engine 100 through an air cleaner 102. An intake air amount is adjusted by a throttle valve 104. The throttle valve 104 is driven by a throttle motor 312.

Intake air is mixed with fuel in each cylinder 106 (combustion chamber). Fuel is injected from each injector 108 to the corresponding cylinder 106. In this embodiment, the engine 100 will be described as a port injection type in which an injection hole of the injector 108 is provided in an intake port. In addition to the port injection injector 108, a direct injection injector that directly injects fuel into the corresponding cylinder 106 may be provided. Furthermore, only a direct injection injector may be provided.

Air-fuel mixture in each cylinder 106 is ignited by a corresponding ignition plug 110 to combust. The combusted air-fuel mixture, that is, exhaust gas, is purified by a three-way catalyst 112, and is then emitted to the outside of the vehicle. A piston 114 is pushed downward by combustion of air-fuel mixture, and a crankshaft 116 rotates.

The intake valve 118 and an exhaust valve 120 are provided at the top portion of each cylinder 106. The amount of air that is introduced into each cylinder 106 and the timing of introduction are controlled by the corresponding intake valve 118. The amount of exhaust gas that is emitted from each cylinder 106 and the timing of emission are controlled by the corresponding exhaust valve 120. Each intake valve 118 is driven by a cam 122. Each exhaust valve 120 is driven by a cam 124.

As will be described in detail later, the valve lift and valve operating angle of each intake valve 118 are controlled by a variable valve lift (VVL) device 400. The valve lift and valve operating angle of each exhaust valve 120 may also be controllable. A variable valve timing (VVT) device that controls the open/close timing of each valve may be combined with the VVL device 400.

The controller 200 controls a throttle opening degree θth, an ignition timing, a fuel injection timing, a fuel injection amount, and the operating state (open/close timing, valve lift, valve operating angle, and the like) of each intake valve so that the engine 100 is placed in a desired operating state. Signals are input to the controller 200 from various sensors, that is, a cam angle sensor 300, a crank angle sensor 302, a knock sensor 304, a throttle opening degree sensor 306, an accelerator pedal sensor 308, a coolant temperature sensor 309 and an outside air temperature sensor 310.

The cam angle sensor 300 outputs a signal indicating a cam position. The crank angle sensor 302 outputs signals indicating the rotation speed of the crankshaft 116 (engine rotation speed) and the rotation angle of the crankshaft 116. The knock sensor 304 outputs a signal indicating the strength of vibrations of the engine 100. The throttle opening degree sensor 306 outputs a signal indicating the throttle opening degree θth.

The accelerator pedal sensor 308 detects a driver's operation amount of an accelerator pedal, and outputs a signal Ac to the controller 200. The signal Ac indicates the detected operation amount. The coolant temperature sensor 309 detects a coolant temperature Tw of the engine 100. The outside air temperature sensor 310 detects an outside air temperature Ta around the hybrid vehicle 1. The detected coolant temperature Tw and the detected outside air temperature Ta are input to the controller 200. The controller 200 controls the engine 100 on the basis of the signals from these sensors.

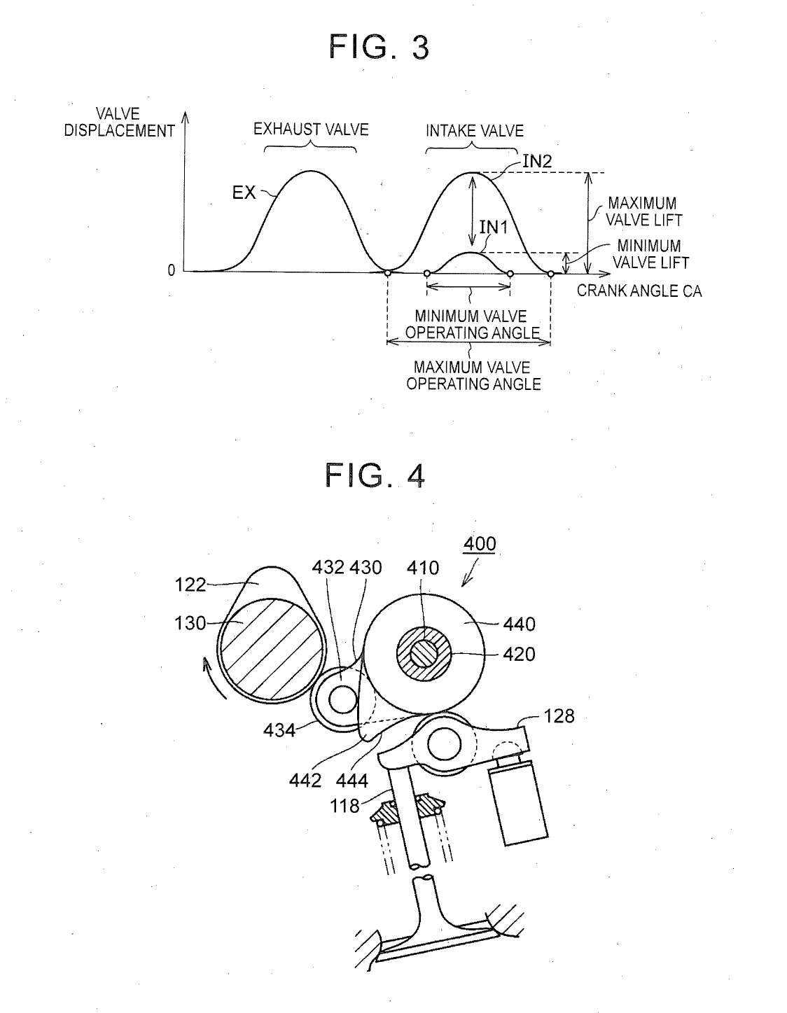

FIG. 3 is a graph that shows the correlation between a crank angle and a valve displacement that is achieved by the VVL device 400. As shown in FIG. 3, each exhaust valve 120 (FIG. 2) opens and closes in an exhaust stroke, and each intake valve 118 (FIG. 2) opens and closes in an intake stroke. A waveform EX indicates the valve displacement of each exhaust valve 120. Waveforms IN1, IN2 each indicate a valve displacement of each intake valve 118. The valve displacement is a displacement of a valve from a state where the valve is closed. In the following description, the valve lift is a valve displacement at the time when the opening degree of the intake valve 118 has reached a peak, and the valve operating angle is a crank angle of a period from when the intake valve 118 opens to when the intake valve 118 closes.

The operation characteristic of each intake valve 118 is changed by the VVL device 400 between the waveforms IN1, IN2. The waveform IN1 indicates the case where the valve lift and the valve operating angle are minimum. The waveform IN2 indicates the case where the valve lift and the valve operating angle are maximum. In the VVL device 400, the valve operating angle increases with an increase in the valve lift.

FIG. 4 is a front view of the VVL device 400. The configuration shown in FIG. 4 is one example. The VVL device 400 is not limited to such a configuration. As shown in FIG. 4, the VVL device 400 includes a drive shaft 410, a support pipe 420, an input arm 430, and oscillation cams 440. The drive shaft 410 extends in one direction. The support pipe 420 covers the outer periphery of the drive shaft 410. The input arm 430 and the oscillation cams 440 are arranged in the axial direction of the drive shaft 410 on the outer periphery of the support pipe 420. An actuator (not shown) that linearly actuates the drive shaft 410 is connected to the distal end of the drive shaft 410.

The VVL device 400 includes the one input arm 430 in correspondence with the one cam 122 provided in each cylinder. The two oscillation cams 440 are provided on both sides of each input arm 430 in correspondence with the pair of intake valves 118 provided for each cylinder.

The support pipe 420 is formed in a hollow cylindrical shape, and is arranged parallel to a camshaft 130. The support pipe 420 is fixed to a cylinder head so as not to be moved in the axial direction or rotated.

The drive shaft 410 is inserted inside the support pipe 420 so as to be slidable in the axial direction. The input arm 430 and the two oscillation cams 440 are provided on the outer periphery of the support pipe 420 so as to be oscillatable about the axis of the drive shaft 410 and not to move in the axial direction.

The input arm 430 includes an arm portion 432 and a roller portion 434. The arm portion 432 protrudes in a direction away from the outer periphery of the support pipe 420. The roller portion 434 is rotatably connected to the distal end of the arm portion 432. The input arm 430 is provided such that the roller portion 434 is arranged at a position at which the roller portion 434 is able to contact the cam 122.

Each oscillation cam 440 has a substantially triangular nose portion 442 that protrudes in a direction away from the outer periphery of the support pipe 420. A concave cam face 444 is formed at one side of the nose portion 442. A roller rotatably attached to a rocker arm 128 is pressed against the cam face 444 by the urging force of a valve spring provided in the intake valve 118.

The input arm 430 and the oscillation cams 440 integrally oscillate about the axis of the drive shaft 410. Therefore, as the camshaft 130 rotates, the input arm 430 that is in contact with the cam 122 oscillates, and the oscillation cams 440 oscillate in interlocking with movement of the input arm 430. The movements of the oscillation cams 440 are transferred to the intake valves 118 via the rocker arms 128, and the intake valves 118 are opened or closed.

The VVL device 400 further includes a device that changes a relative phase difference between the input arm 430 and each oscillation cam 440 around the axis of the support pipe 420. The valve lift and valve operating angle of each intake valve 118 are changed as needed by the device that changes the relative phase difference.

That is, when the relative phase difference between the input arm 430 and each oscillation cam 440 is increased, the oscillation angle of each rocker arm 128 is increased with respect to the oscillation angle of each of the input arm 430 and the oscillation cams 440, and the valve lift and valve operating angle of each intake valve 118 are increased.

When the relative phase difference between the input arm 430 and each oscillation cam 440 is reduced, the oscillation angle of each rocker arm 128 is reduced with respect to the oscillation angle of each of the input arm 430 and the oscillation cams 440, and the valve lift and valve operating angle of each intake valve 118 are reduced.

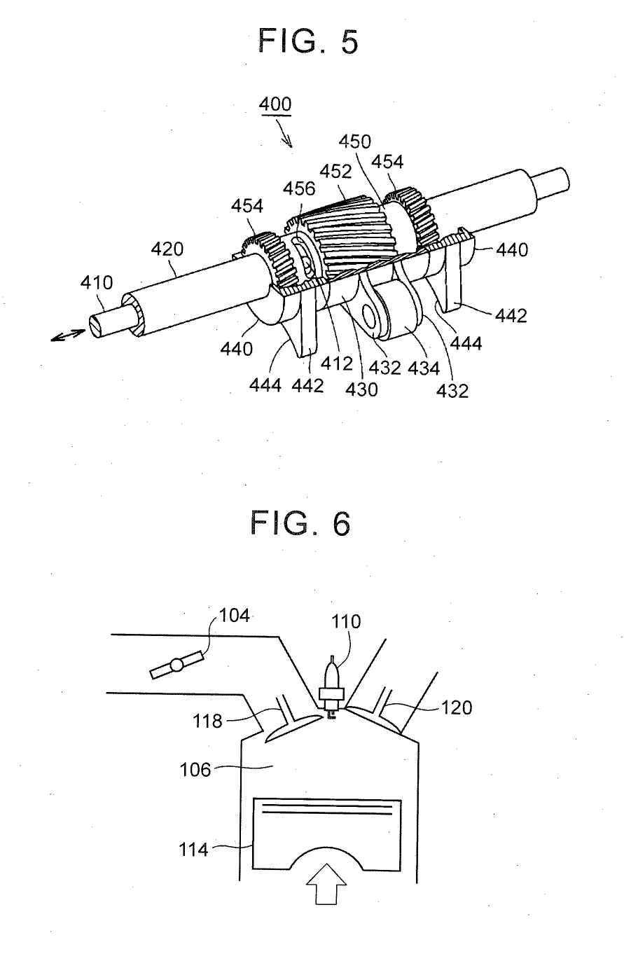

FIG. 5 is a perspective view that partially shows the VVL device 400 shown in FIG. 4. FIG. 5 shows a structure with part cut away so that the internal structure is understood. As shown in FIG. 5, a slider gear 450 is accommodated in a space defined between the outer periphery of the support pipe 420 and the set of input arm 430 and two oscillation cams 440. The slider gear 450 is supported on the support pipe 420 so as to be rotatable and slidable in the axial direction. The slider gear 450 is provided on the support pipe 420 so as to be slidable in the axial direction.

The slider gear 450 includes a helical gear 452. The helical gear 452 is located at the center portion of the slider gear 450 in the axial direction. Right-handed screw spiral helical splines are formed on the helical gear 452. The slider gear 450 includes helical gears 454. The helical gears 454 are respectively located on both sides of the helical gear 452. Left-handed screw spiral helical splines opposite to those of the helical gear 452 are formed on each of the helical gears 454.

On the other hand, helical splines corresponding to the helical gears 452, 454 are respectively formed on the inner peripheries of the input arm 430 and two oscillation cams 440. The inner peripheries of the input arm 430 and two oscillation cams 440 define a space in which the slider gear 450 is accommodated. That is, the right-handed spiral helical splines are formed on the input arm 430, and the helical splines are in mesh with the helical gear 452. The left-handed spiral helical splines are formed on each of the oscillation cams 440, and the helical splines are in mesh with the corresponding helical gear 454.

An oblong hole 456 is formed in the slider gear 450. The oblong hole 456 is located between the helical gear 452 and one of the helical gears 454, and extends in the circumferential direction. Although not shown in the drawing, an oblong hole is formed in the support pipe 420, and the oblong hole extends in the axial direction so as to partially overlap with the oblong hole 456. A locking pin 412 is integrally provided in the drive shaft 410 inserted inside the support pipe 420. The locking pin 412 protrudes through the overlapped portions of these oblong hole 456 and oblong hole (not shown).

When the drive shaft 410 is moved in the axial direction by the actuator (not shown) coupled to the drive shaft 410, the slider gear 450 is pressed by the locking pin 412, and the helical gears 452, 454 move in the axial direction of the drive shaft 410 at the same time. When the helical gears 452, 454 are moved in this way, the input arm 430 and the oscillation cams 440 spline-engaged with these helical gears 452, 454 do not move in the axial direction. Therefore, the input arm 430 and the oscillation cams 440 pivot around the axis of the drive shaft 410 through meshing of the helical splines.

At this time, the helical splines respectively formed on the input arm 430 and each oscillation cam 440 have opposite orientations. Therefore, the pivot direction of the input arm 430 and the pivot direction of each oscillation cam 440 are opposite to each other. Thus, the relative phase difference between the input arm 430 and each oscillation cam 440 changes, with the result that the valve lift and valve operating angle of each intake valve 118 are changed as is already described.

The VVL device 400 is not limited to this type. For example, a VVL device that electrically drives each valve, a VVL device that hydraulically drives each valve, or the like, may be used.

The controller 200 (shown in FIG. 2) controls the valve lift and valve operating angle of each intake valve 118 by adjusting an operation amount of the actuator that linearly moves the drive shaft 410.

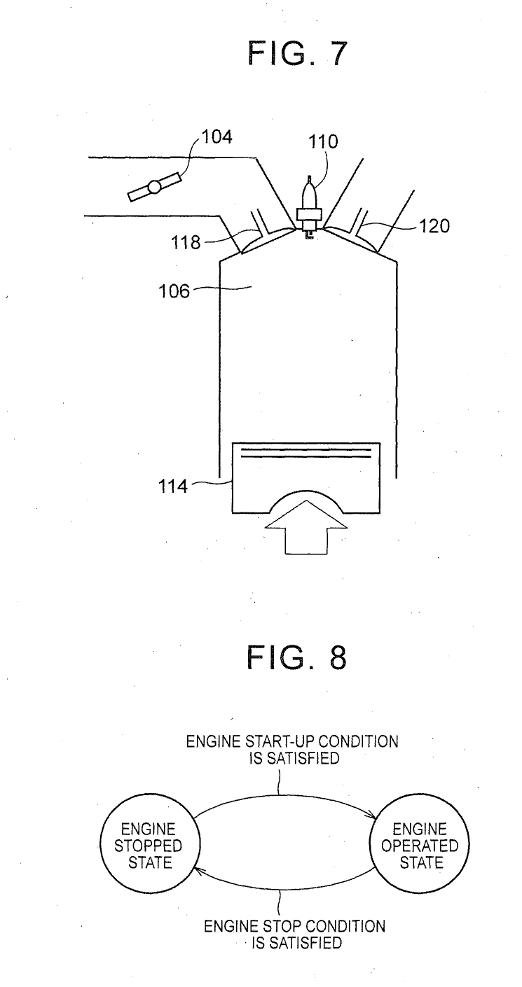

FIG. 6 is a view that illustrates an operation at the time when the valve lift and valve operating angle of each intake valve 118 are large. FIG. 7 is a view that illustrates an operation at the time when the valve lift and valve operating angle of each intake valve 118 are small.

As shown in FIG. 6 and FIG. 7, when the valve lift and valve operating angle of each intake valve 118 are large (hereinafter, also referred to as “large cam state”), because the close timing of each intake valve 118 delays, the engine 100 runs on the Atkinson cycle. That is, part of air taken into the cylinder 106 in the intake stroke is returned to the outside of the cylinder 106, so compression reaction that is a force for compressing air decreases in the compression stroke (decompression). Thus, it is possible to reduce vibrations at engine start-up. Thus, in the hybrid vehicle in which the number of engine start-up processes increases because the engine 100 is intermittently operated, it is desirable to increase the valve lift and valve operating angle of each intake valve 118 at engine start-up in order to obtain decompression. When the valve lift and valve operating angle of each intake valve 118 are increased, ignitability deteriorates because of a reduction in compression ratio, so engine startability relatively deteriorates.

On the other hand, when the valve lift and valve operating angle of each intake valve 118 are small (hereinafter, also referred to as “small cam state”), because the close timing of each intake valve 118 advances, the compression ratio increases. Therefore, ignitability improves at a low temperature, and the response of engine torque improves. When the valve lift and valve operating angle of each intake valve 118 are reduced, compression reaction increases, so vibrations at engine start-up increase.

FIG. 8 is a transition diagram that illustrates intermittent operation control over the engine in the hybrid vehicle 1 shown in FIG. 1. As shown in FIG. 8, in the hybrid vehicle 1, start-up and stop of the engine 100 are basically automatically controlled on the basis of a traveling state. The controller 200 generates an engine start-up command when an engine start-up condition is satisfied in an engine stopped state. Thus, the engine start-up process is executed, with the result that the hybrid vehicle 1 shifts from the engine stopped state to an engine operated state.

On the other hand, the controller 200 generates an engine stop command when an engine stop condition is satisfied in the engine operated state. Thus, the engine stop process is executed, with the result that the hybrid vehicle 1 shifts from the engine operated state to the engine stopped state.

For example, in the hybrid vehicle 1, it is determined on the basis of a comparison between an output parameter Pr and a threshold whether the engine start-up condition is satisfied. The output parameter Pr quantitatively indicates an output (power or torque) that is required of the hybrid vehicle 1. That is, when the output parameter Pr exceeds a predetermined threshold Pth1, the engine start-up condition is satisfied.

For example, the output parameter Pr is a total required power Pt1 of the hybrid vehicle 1. The total required power Pt1 is allowed to be calculated from the sum of a required driving power Pr* and a required charge/discharge power Pchg (Pt1=Pr*+Pchg). The required driving power Pr* is expressed by the product of a required torque Tr* and the rotation speed of the drive shaft 8. The required torque Tr* reflects a driver's accelerator pedal operation amount. The required charge/discharge power Pchg is used to control the SOC of the electrical storage device 10.

The required torque Tr* is set to a higher value as the accelerator pedal operation amount increases. In combination with the vehicle speed, it is desirable to set the required torque Tr* such that the required torque Tr* decreases as the vehicle speed increases for the same accelerator operation amount. It is applicable to previously create a map by reflecting these characteristics. The required torque Tr* is set on the basis of the accelerator pedal operation amount and the vehicle speed by using the map. Alternatively, it is also applicable to set the required torque Tr* additionally on the basis of a road surface state (road surface gradient, road surface friction coefficient, or the like) in accordance with a preset map or arithmetic expression.

The required charge/discharge power Pchg is set on the basis of the SOC. That is, the required charge/discharge power Pchg is set to Pchg>0 (charge) when the SOC has decreased, while the charge/discharge power Pchg is set to Pchg<0 (discharge) when the SOC has increased. That is, the required charge/discharge power Pchg is set so as to bring the SOC of the electrical storage device 10 close to a predetermined control target. In the case where the hybrid vehicle 1 has a charge depleting (CD) mode in which the SOC is consumed and a charge sustaining (CS) mode in which the SOC is kept, the required charge/discharge power Pchg is set to zero (Pchg=0) in the CD mode, whereas the required charge/discharge power Pchg is set on the basis of the SOC in the CS mode. That is, in the CS mode, the required charge/discharge power Pchg is set to Pchg>0 (charge) when the SOC has decreased, while the required charge/discharge power Pchg is set to Pchg<0 (discharge) when the SOC has increased. Such mode control for changing between the CD mode and the CS mode is useful for a hybrid vehicle of which the electrical storage device 10 is chargeable from a power supply outside the vehicle, and is also applicable to a hybrid vehicle that has no function of charging the electrical storage device 10 from a power supply outside the vehicle.

The controller 200 controls the outputs of the engine 100 and motor generators MG1, MG2 so that the total required power Pt1 is generated. For example, when the total required power Pt1 is small, for example, during low-speed traveling, the engine 100 is stopped. On the other hand, during acceleration based on accelerator pedal operation, the engine start-up condition is satisfied as a result of an increase in the total required power Pt1, with the result that the engine 100 is started up.

On the other hand, the engine stop condition is satisfied when the output parameter Pr (total required power Pt1) becomes lower than a predetermined threshold Pth2. It is desirable to prevent frequent change between the engine stopped state and the engine operated state by setting the threshold Pth1 of the engine start-up condition and the threshold Pth2 of the engine stop condition to different values (Pth1>Pth2).

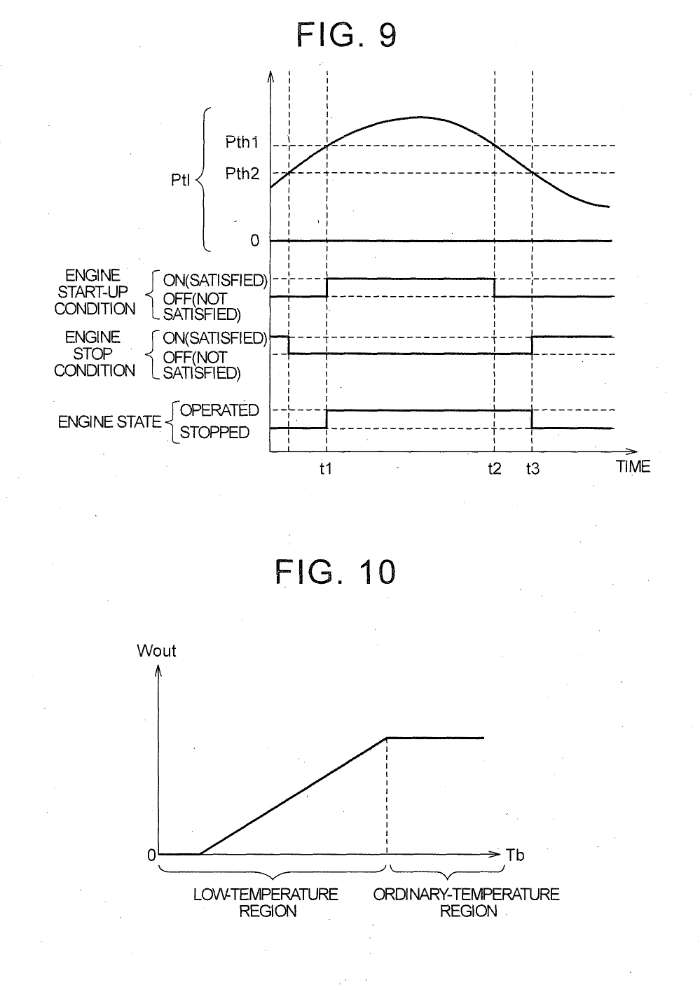

FIG. 9 is a time chart that shows an example of engine intermittent operation. As shown in FIG. 9, at time t1, when the total required power Pt1 exceeds the threshold Pth1, an engine start-up condition is set to an on state (satisfied). Thus, the engine start-up process is executed, with the result that the hybrid vehicle 1 shifts from the engine stopped state to the engine operated state.

When the total required power Pt1 becomes lower than the threshold Pth1 at time t2, the engine start-up condition is set to an off state (not satisfied). When the total required, power Pt1 becomes lower than the threshold Pth2 (Pth1>Pth2) at time t3, the engine stop condition is set to an on state (satisfied). Thus, the engine stop process is executed, with the result that the hybrid vehicle 1 shifts from the engine operated state to the engine stopped state.

Referring back to FIG. 8, when warm-up of the three-way catalyst 112 is required, for example, at a low temperature of the engine 100 as well, the engine start-up condition is satisfied, and then the engine 100 is started up. In the case where the engine 100 is started up in order to warm up the three-way catalyst 112, and the like, the engine stop condition is satisfied when a catalyst temperature or engine coolant temperature (coolant temperature sensor 309) becomes higher than a predetermined temperature. When vehicle operation is stopped in response to user's key switch operation (for example, when an IG switch is turned off) as well, the engine stop condition is satisfied.

The output parameter Pr for determining whether to operate or stop the engine 100 may be other than the total required power Pt1. For example, a required torque or required acceleration that is calculated so as to reflect at least an accelerator pedal operation amount, or an accelerator pedal operation amount itself may be used as the output parameter Pr.

In order to start up the engine 100 in a stopped state, the engine 100 is cranked by the motor generator MG1. At the time of cranking, electric power is supplied from the electrical storage device 10 to the motor generator MG1. Thus, when the output (discharge) of the electrical storage device 10 is significantly limited at engine start-up, there is a concern that cranking torque sufficient to start up the engine 100 cannot be applied to the engine 100 by the motor generator MG1. Particularly, in the case where the valve lift and valve operating angle of each intake valve 118 are increased (large cam state) in order to reduce vibrations at engine start-up, when the output from the electrical storage device 10 is significantly limited, deterioration of startability of the engine 100 is remarkable.

The output (discharge) of the electrical storage device 10 is limited by setting a discharge power upper limit value Wout that is changed on the basis of the temperature Tb, SOC, degree of degradation, and the like, of the electrical storage device 10. FIG. 10 to FIG. 12 are conceptual views for illustrating limitations on the output from the electrical storage device 10.

FIG. 10 shows the correlation between the temperature Tb of the electrical storage device 10 and the discharge power upper limit value Wout. As shown in FIG. 10, particularly, when the electrical storage device 10 is formed of a secondary battery, the discharge power upper limit value Wout is limited by an increase in internal resistance in a low-temperature region. For example, on the basis of the temperature Tb of the electrical storage device 10, the discharge power upper limit value Wout is more limited in a low-temperature region than in an ordinary-temperature region.

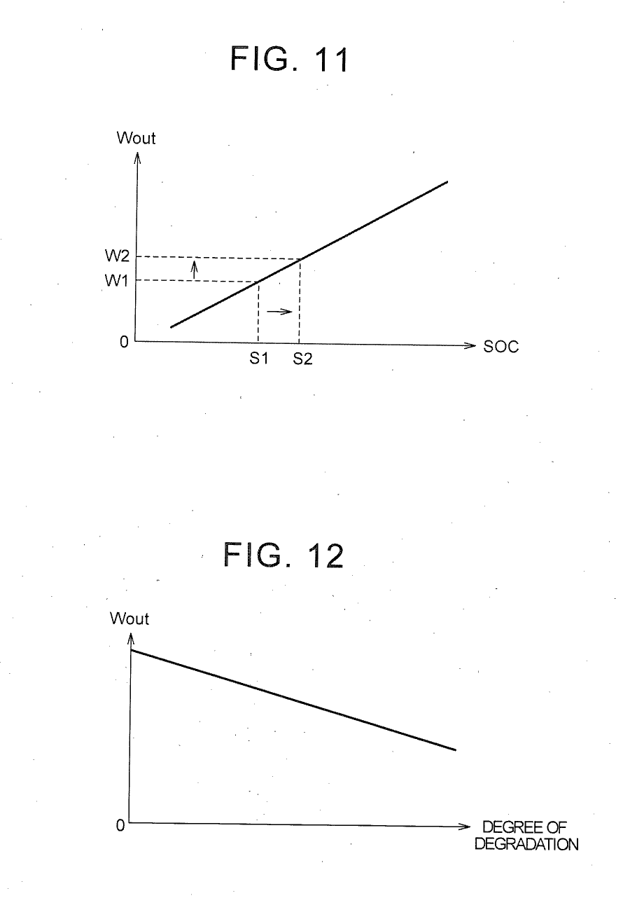

FIG. 11 shows the correlation between the SOC of the electrical storage device 10 and the discharge power upper limit value Wout. As shown in FIG. 11, in order to prevent overdischarging of the electrical storage device 10, the discharge power upper limit value Wout is set so that the discharge power upper limit value Wout decreases as the SOC decreases. The SOC of the electrical storage device 10 may be calculated by using various known methods on the basis of the detected values of the voltage Vb, current IB and temperature Tb of the electrical storage device 10.

In order to prevent overdischarging of the electrical storage device 10, the SOC is controlled so as to be higher than a predetermined control lower limit. When the control lower limit of the SOC is set to a value S1, the discharge power upper limit value Wout is set to a value higher than a value W1 on the basis of the SOC. When the control lower limit of the SOC is increased from the value S1 to a value S2, the discharge power upper limit value Wout is set to a value higher than a value W2 (W1<W2) on the basis of the SOC. That is, the SOC is increased by increasing the control lower limit of the SOC from the value S1 to the value S2, it is possible to increase the discharge power upper limit value Wout.

FIG. 12 is a graph that shows the correlation between the degree of degradation of the electrical storage device 10 and the discharge power upper limit value Wout. As shown in FIG. 12, the discharge power upper limit value Wout is set so that the discharge power upper limit value Wout decreases as the degradation of the electrical storage device 10 advances. The degree of degradation of the electrical storage device 10 may be calculated by using various known methods.

In this way, the discharge power upper limit value Wout of the electrical storage device 10 is set on the basis of the temperature Tb, SOC, degree of degradation, and the like, of the electrical storage device 10. In order to protect the electrical storage device 10, respective torque command values of the motor generators MG1, MG2 are limited so that the sum of electric power consumptions (torque×rotation speed) of the motor generators MG1, MG2 does not exceed the discharge power upper limit value Wout.

When the output from the electrical storage device 10 is significantly limited while the valve lift and valve operating angle of each intake valve 118 are increased (large cam state) in order to reduce vibrations at engine start-up, startability of the engine 100 significantly deteriorates because of a decrease in engine startability resulting from decompression and a decrease in cranking torque: Therefore, in the first embodiment, when start-up of the engine 100 is required, the discharge power upper limit value Wout is increased by increasing the control lower limit of the SOC of the electrical storage device 10 (FIG. 11). Thus, a decrease in cranking torque is suppressed, so startability of the engine 100 is ensured. More specifically, when it is determined that startability of the engine 100 deteriorates at the time when the process of stopping the engine 100 is executed on the assumption that the engine 100 is restarted (for example, at a low temperature), the control lower limit of the SOC is increased as compared to that during normal times.

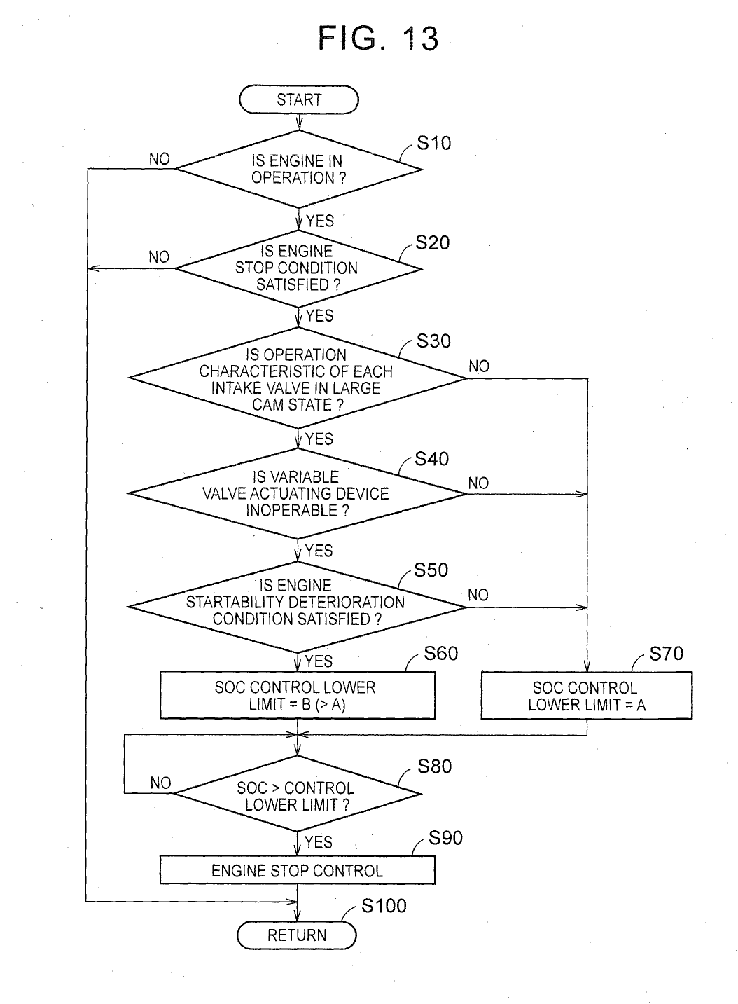

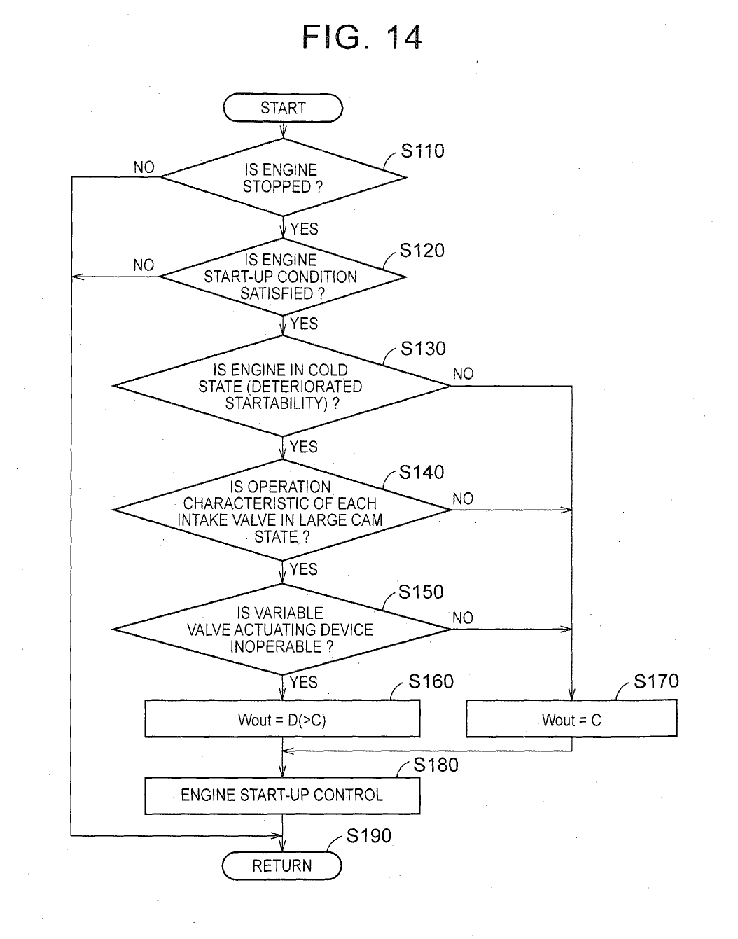

FIG. 13 is a flowchart that illustrates the control structure of intake valve control in the hybrid vehicle 1 according to the first embodiment. This flowchart is implemented by the controller 200 executing a prestored program at predetermined intervals. Alternatively, the processes of part of the steps may be implemented by constructing exclusive hardware (electronic circuit).

As shown in FIG. 13, the controller 200 determines whether the engine 100 is operating (step S10). When the engine 100 is stopped (NO in step S10), the controller 200 proceeds with the process to step S100 without executing the following series of processes.

When it is determined in step S10 that the engine 100 is operating (YES in step S10), the controller 200 determines whether the engine stop condition described with reference to FIG. 8 is satisfied (step S20). When it is determined that the engine stop condition is satisfied (YES in step S20), the controller 200 determines whether the operation characteristic of each intake valve 118 is in the large cam state (in a state where the valve lift and the valve operating angle are relatively large, and, for example, in a state indicated by the waveform IN2 shown in FIG. 3) (step S30).

When it is determined that the operation characteristic of each intake valve 118 is in the large cam state (YES in step S30), the controller 200 determines whether the

VVL device 400 is inoperable (step S40). At the time of a failure of the VVL device 400 or at the time of an increase in friction in an extremely low temperature condition, the VVL device 400 can be inoperable. Step S40 may be omitted.

When it is determined in step S40 that the VVL device 400 is inoperable (YES in step S40), the controller 200 determines whether a condition for deterioration of startability of the engine 100 is satisfied (step S50). For example, as a condition that is set on the basis of the electrical storage device 10, when the discharge power upper limit value Wout is lower than a predetermined value or when the temperature Tb of the electrical storage device 10 is lower than a predetermined temperature, it is determined that the condition is satisfied. As a condition that is set on the basis of the engine 100, when the coolant temperature Tw of the engine 100 or the outside air temperature Ta is lower than a predetermined temperature or when a current location that is detected by a navigation system (not shown) indicates a low-temperature region (a highland, a high latitude, or the like), it is determined that the condition is satisfied.

When it is determined in step S50 that the engine startability deterioration condition is satisfied (YES in step S50), the controller 200 sets a predetermined value B for the control lower limit of the SOC of the electrical storage device 10 (step S60). The predetermined value B is a value higher than a predetermined value A, and increases the output from the electrical storage device 10 in order to apply sufficient cranking torque to the engine 100 by the motor generator MG1. The predetermined value A is set on the basis of the state (the temperature Tb, SOC, degree of degradation, and the like) of the electrical storage device 10 at this time. That is, the discharge power upper limit value

Wout is increased by increasing the SOC as a result of increasing the control lower limit of the SOC (FIG. 11), with the result that the output from the electrical storage device 10 is increased.

When it is determined in step S30 that the operation characteristic of each intake valve 118 is not in the large cam state (NO in step S30), when it is determined in step S40 that the VVL device 400 is not inoperable (NO in step S40) or when it is determined in step S50 that the engine startability deterioration condition is not satisfied (NO in step S50), the controller 200 sets the above-described predetermined value A for the control lower limit of the SOC (step S70).

When the control lower limit of the SOC is set in step S60 or step S70, the controller 200 determines whether the SOC is higher than the set control lower limit (step S80). When it is determined that the SOC is higher than the control lower limit (YES in step S80), the controller 200 executes control for stopping the engine 100 (step S90). Thus, fuel injection from each injector 108 is stopped, and the torque of the motor generator MG1 is controlled so as to smoothly stop the engine 100.

As described above, in the first embodiment, at the time when the engine stop condition is satisfied, when the operation characteristic of each intake valve 118 is in the large cam state (in the state where the valve lift and the valve operating angle are relatively large) and the engine startability deterioration condition is satisfied, the control lower limit of the SOC of the electrical storage device 10 is increased. When the SOC is lower than the control lower limit, the engine 100 is stopped after the SOC becomes higher than the control lower limit. Thus, the discharge power upper limit value Wout at the next engine restart is increased, so it is possible to increase the output from the electrical storage device 10. As a result, it is possible to increase cranking torque that is applied to the engine 100 by the motor generator MG1. Thus, according to the first embodiment, it is possible to suppress vibrations at start-up of the engine 100 and to ensure startability of the engine 100.

According to the first embodiment, because the above-described process of increasing the control lower limit of the SOC of the electrical storage device 10 is executed when the engine startability deterioration condition is satisfied at the time when the process of stopping the engine 100 is executed, it is possible to suppress inhibition of flexibility of control over the SOC resulting from an unnecessary increase in the control lower limit of the SOC.

In the first embodiment, by increasing the control lower limit of the SOC of the electrical storage device 10 at the time when the process of stopping the engine 100 is executed, the discharge power upper limit value Wout is increased, thus increasing the output from the electrical storage device 10. In a second embodiment, the output from the electrical storage device 10 is increased by directly increasing the discharge power upper limit value Wout at the time when the process of starting up the engine 100 is executed.

The overall configuration of the hybrid vehicle and the configuration of the engine according to the second embodiment are the same as those of the hybrid vehicle 1 and engine 100 according to the first embodiment.

FIG. 14 is a flowchart that illustrates the control structure of intake valve control in the hybrid vehicle 1 according to the second embodiment. This flowchart is also implemented by the controller 200 executing a prestored program at predetermined intervals. Alternatively, the processes of part of the steps may be implemented by constructing exclusive hardware (electronic circuit).

As shown in FIG. 14, the controller 200 determines whether the engine 100 is stopped (step S110). When the engine 100 is operating (NO in step S110), the controller 200 proceeds with the process to step S190 without executing the following series of processes.

When it is determined in step S110 that the engine 100 is stopped (YES in step S110), the controller 200 determines whether the engine start-up condition described with reference to FIG. 8 is satisfied (step S120). When it is determined that the engine start-up condition is satisfied (YES in step S120), the controller 200 determines whether the engine 100 is in a cold state due to a decrease in air temperature, that is whether startability of the engine 100 can deteriorate (step S130). Specifically, when the coolant temperature Tw of the engine 100 is lower than a predetermined value indicating that the engine 100 is in a low temperature state, it is determined that the engine 100 is in the cold state. Instead of the coolant temperature Tw of the engine 100, it may be determined on the basis of the oil temperature of the engine 100 whether the engine 100 is in the cold state.

When it is determined that the engine 100 is in the cold state (YES in step S130), the controller 200 determines whether the operation characteristic of each intake valve 118 is in the large cam state (in the state where the valve lift and the valve operating angle are relatively large, and, for example, in the state indicated by the waveform IN2 shown in FIG. 3) (step S140).

When it is determined that the operation characteristic of each intake valve 118 is in the large cam state (YES in step S140), the controller 200 determines whether the VVL device 400 is inoperable (step S150). As described above, at the time of a failure of the VVL device 400 or at the time of an increase in friction in an extremely low temperature condition, the VVL device 400 can be inoperable. Step S150 may be omitted.

When it is determined in step S150 that the VVL device 400 is inoperable (YES in step S150), the controller 200 sets a predetermined value D for the discharge power upper limit value Wout (step S160). The predetermined value D is a value higher than a predetermined value C, and increases the output from the electrical storage device 10 in order to apply sufficient cranking torque to the engine 100 by the motor generator MG1. The predetermined value C is set on the basis of the state of the electrical storage device 10 at this time. That is, by increasing the discharge power upper limit value Wout, the output from the electrical storage device 10 is increased.

When it is determined in step S130 that the engine 100 is not in the cold state (NO in step S130), when it is determined in step S140 that the operation characteristic of each intake valve 118 is not in the large cam state (NO in step S140) or when it is determined in step S150 that the VVL device 400 is operable (NO in step S150), the controller 200 sets the above-described predetermined value C for the discharge power upper limit value Wout (step S170).

When the discharge power upper limit value Wout is set in step S160 or step S170, the controller 200 executes control for starting up the engine 100 (step S180). Thus, in a state where the engine 100 is rotationally driven by cranking torque generated by the motor generator MG1, fuel injection from each injector 108 and ignition of each ignition plug 110 are started.

As described above, in the second embodiment, at the time when the engine start-up condition is satisfied, when the operation characteristic of each intake valve 118 is in the large cam state (in the state where the valve lift and the valve operating angle are relatively large) and the engine 100 is in the cold state (deteriorated startability), the discharge power upper limit value Wout is increased. Thus, it is possible to increase the output from the electrical storage device 10 at engine start-up, so it is possible to increase cranking torque that is applied to the engine 100 by the motor generator MG1. Thus, according to the second embodiment, it is possible to suppress vibrations at start-up of the engine 100 and to ensure startability of the engine 100.

According to the second embodiment, because the above-described process of increasing the discharge power upper limit value Wout is executed at the time when the process of starting up the engine 100 is executed, it is possible to suppress advance of degradation of the electrical storage device 10 resulting from an unnecessary increase in the discharge power upper limit value Wout.

The second embodiment may be implemented in combination with the above-described first embodiment. That is, at the time when the process of stopping the engine 100 is executed, the process of increasing the control lower limit of the SOC, described in the first embodiment, may be executed, and, at the time of the next start-up of the engine 100, the process of increasing the discharge power upper limit value Wout, described in the second embodiment, may be executed.

In the above-described embodiments, the valve lift and valve operating angle of each intake valve 118 may be changed continuously (steplessly) or may be changed discretely (stepwisely).

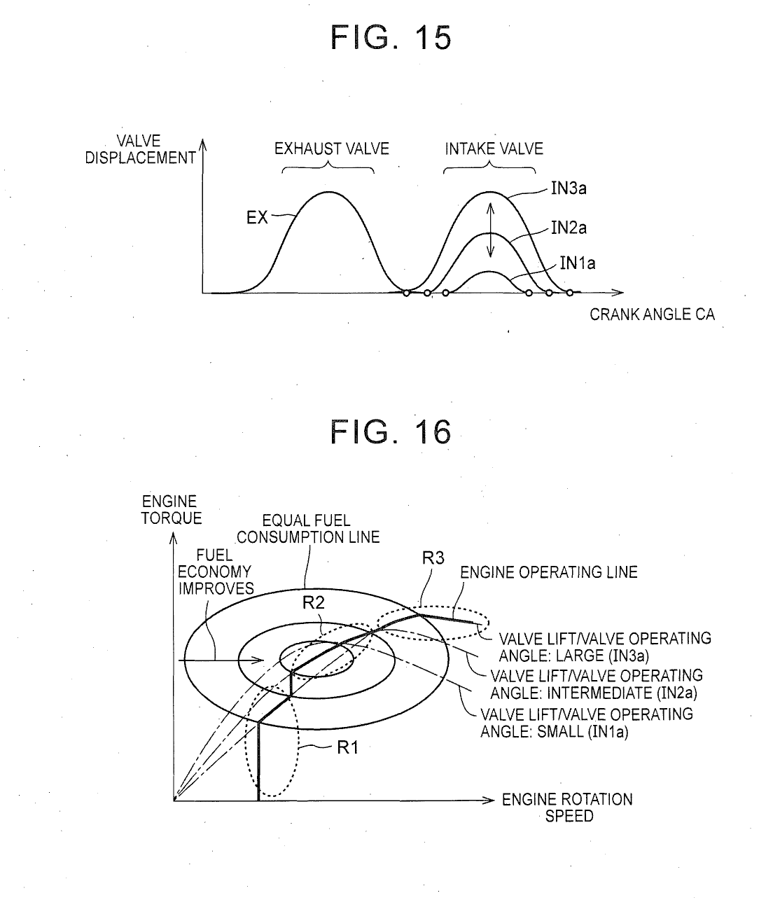

FIG. 15 is a graph that shows the correlation between a crank angle and a valve displacement that is achieved by a VVL device 400A that is able to change the operation characteristic of each intake valve 118 in three steps. As shown in FIG. 15, the VVL device 400A is able to change the operation characteristic to any one of first to third characteristics. The first characteristic is indicated by a waveform IN1a. The second characteristic is indicated by a waveform IN2a. The valve lift and the valve operating angle in the second characteristic are larger than the valve lift and the valve operating angle in the first characteristic. The third characteristic is indicated by a waveform IN3a. The valve lift and the valve operating angle in the third characteristic are larger than the valve lift and the valve operating angle in the second characteristic.

FIG. 16 is a graph that shows an operating line of the engine 100 including the VVL device 400A having the operation characteristics shown in FIG. 15. As shown in FIG. 16, the abscissa axis represents engine rotation speed, and the ordinate axis represents engine torque. The lines indicated by the alternate long and short dashed line indicate torque characteristics respectively corresponding to the first to third characteristics (IN1a to IN3a). The circles indicated by the continuous line indicate equal fuel consumption lines. The fuel economy improves as approaching the center of the circles. The engine 100 is basically operated along the engine operating line indicated by the continuous line.

In a low rotation speed region indicated by the region R1, it is important to suppress vibrations at engine start-up. In this low rotation speed region, introduction of exhaust gas recirculation (EGR) gas is stopped, and fuel economy is improved by using the Atkinson cycle. Thus, in the region R1, the third characteristic (IN3a) is selected as the operation characteristic of each intake valve 118 such that the valve lift and the valve operating angle increase. In an intermediate rotation speed region indicated by the region R2, fuel economy is improved by increasing the amount of introduction of EGR gas. Thus, in the region R2, the second characteristic (IN2a) is selected as the operation characteristic of each intake valve 118 such that the valve lift and the valve operating angle are intermediate.

That is, when the valve lift and valve operating angle of each intake valve 118 are large (third characteristic), improvement in fuel economy by using the Atkinson cycle is given a higher priority than improvement in fuel economy by introduction of EGR gas. On the other hand, when the intermediate valve lift and valve operating angle are selected (second characteristic), improvement in fuel economy by introduction of EGR gas is given a higher priority than improvement in fuel economy by using the Atkinson cycle.

In a high rotation speed region indicated by the region R3, a large amount of air is introduced into each cylinder by the inertia of intake air, and the output performance is improved by increasing an actual compression ratio. Thus, in the region R3, the third characteristic (IN3a) is selected as the operation characteristic of each intake valve 118 such that the valve lift and the valve operating angle increase.

When the engine 100 is operated at a high load in the low rotation speed region, when the engine 100 is started up at an extremely low temperature or when a catalyst is warmed up, the first characteristic (IN1a) is selected as the operation characteristic of each intake valve 118 such that the valve lift and the valve operating angle reduce. In this way, the valve lift and the valve operating angle are determined on the basis of the operating state of the engine 100.

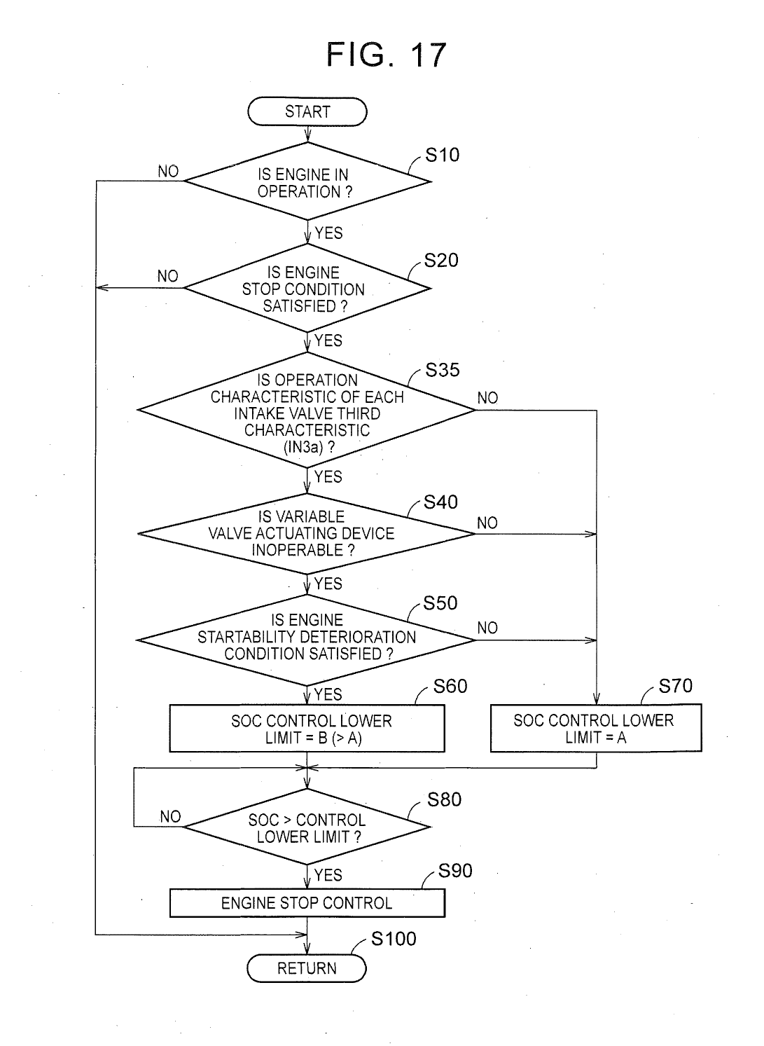

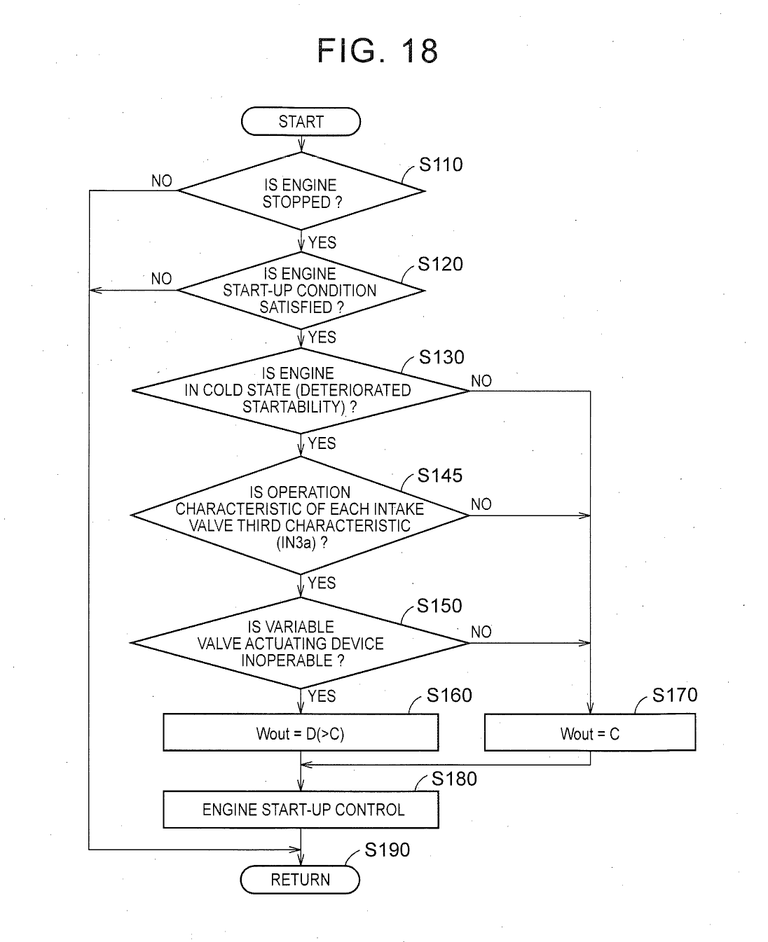

FIG. 17 is a flowchart that illustrates the control structure of intake valve control according to the first embodiment by applying the VVL device 400A having the operation characteristics shown in FIG. 15. As shown in FIG. 17, this flowchart differs from the flowchart shown in FIG. 13 in that step S35 is included instead of step S30.

That is, when it is determined in step S20 that the engine stop condition is satisfied (YES in step S20), the controller 200 determines whether the operation characteristic of each intake valve 118 is the third characteristic (IN3a) (step S35). When it is determined that the operation characteristic of each intake valve 118 is the third characteristic (IN3a) (YES in step S35), the controller 200 proceeds with the process to step S40. When it is determined that the operation characteristic of each intake valve 118 is not the third characteristic (IN3a) (NO in step S35), the controller 200 proceeds with the process to step S70.

Although not specifically shown in the drawing, when it is determined in step S35 that the operation characteristic of each intake valve 118 is the second characteristic (IN2a) as well, the controller 200 may proceed with the process to step S40.

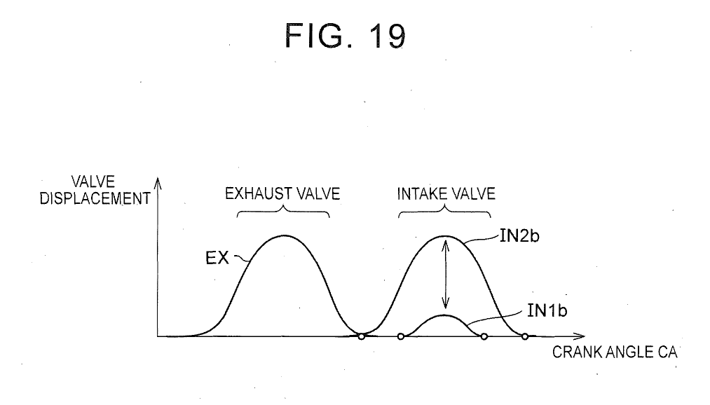

FIG. 18 is a flowchart that illustrates the control structure of intake valve control according to the second embodiment by applying the VVL device 400A having the operation characteristics shown in FIG. 15. As shown in FIG. 18, this flowchart differs from the flowchart shown in FIG. 14 in that step S145 is included instead of step S140.

That is, when it is determined in step S130 that the engine 100 is in the cold state (YES in step S130), the controller 200 determines whether the operation characteristic of each intake valve 118 is the third characteristic (IN3a) (step S145). When it is determined that the operation characteristic of each intake valve 118 is the third characteristic (IN3a) (YES in step S145), the controller 200 proceeds with the process to step S150. When it is determined that the operation characteristic of each intake valve 118 is not the third characteristic (IN3a) (NO in step S145), the controller 200 proceeds with the process to step S170.

Although not specifically shown in the drawing, when it is determined in step S145 that the operation characteristic of each intake valve 118 is the second characteristic (IN2a) as well, the controller 200 may proceed with the process to step S150.

With the VVL device 400A having the operation characteristics shown in FIG. 15, because the operation characteristic, that is, the valve lift and valve operating angle, of each intake valve 118 is limited to three characteristics, it is possible to reduce a time that is required to adapt control parameters for controlling the operating state of the engine 100 in comparison with the case where the valve lift and valve operating angle of each intake valve 118 continuously change. In addition, it is possible to reduce torque that is required of the actuator for changing the valve lift and valve operating angle of each intake valve 118, so it is possible to reduce the size and weight of the actuator. The manufacturing cost of the actuator can also be reduced.

FIG. 19 is a graph that shows the correlation between a crank angle and a valve displacement that is achieved by a VVL device 400B that is able to change the operation characteristic of each intake valve 118 in two steps. As shown in FIG. 19, the VVL device 400B is able to change the operation characteristic to one of first and second characteristics. The first characteristic is indicated by a waveform IN1b. The second characteristic is indicated by a waveform IN2b. The valve lift and the valve operating angle in the second characteristic are larger than the valve lift and the valve operating angle in the first characteristic.

In this case, at the time when the engine stop process is executed, the control lower limit of the SOC is increased in the case where the operation characteristic of each intake valve 118 is the second characteristic (IN2b), and, at the time when the engine start-up process is executed, the discharge power upper limit value Wout can be increased in the case where the operation characteristic of each intake valve 118 is the second characteristic (IN2b).

With the above configuration, because the operation characteristic, that is, the valve lift and the valve operating angle, of each intake valve 118 is limited to two characteristics, it is possible to further reduce a time that is required to adapt control parameters for controlling the operating state of the engine 100. It is also possible to further simplify the configuration of the actuator. The operation characteristic of the valve lift and valve operating angle of each intake valve 118 is not limited to the case where the operation characteristic is changed in two steps or in three steps. The operation characteristic may be changed in any number of steps larger than or equal to four steps.

In the above-described embodiments, the valve operating angle of each intake valve 118 is changed together with the valve lift of each intake valve 118. However, the invention is also applicable to a hybrid vehicle including an engine that includes a variable valve actuating device that is able to change one of the valve lift of each intake valve 118 and the valve operating angle of each intake valve 118. With the variable valve actuating device that is able to change one of the valve lift and valve operating angle of each intake valve 118 as well, it is possible to obtain similar advantageous effects to those of the case where it is possible to change both the valve lift and valve operating angle of each intake valve 118. The variable valve actuating device that is able to change one of the valve lift and valve operating angle of each intake valve 118 may be implemented by utilizing various known techniques.

In the above-described embodiments, the series-parallel hybrid vehicle that is able to transmit the power of the engine 100 by distributing the power of the engine 100 to the drive wheels 6 and the motor generators MG1, MG2 by the power split device 4. The invention is also applicable to a hybrid vehicle of another type. That is, the invention is also applicable to, for example, a so-called series hybrid vehicle in which the engine 100 is only used to drive the motor generator MG1 and the driving force of the vehicle is generated only by the motor generator MG2, a hybrid vehicle in which only regenerative energy within kinetic energy generated by the engine 100 is recovered as electric energy, a motor-assist hybrid vehicle in which the engine is used as a main power source and a motor, where necessary, assists, or the like. The invention is also applicable to a hybrid vehicle that travels by using the power of only the engine while the motor is separated.

In the above description, the engine 100 corresponds to one example of an “internal combustion engine” according to the invention, and the VVL devices 400, 400A, 400B correspond to one example of a “variable valve actuating device” according to the invention.

The embodiments described above are expected to be implemented in appropriate combinations. The embodiments described above should be regarded as only illustrative in every respect and not restrictive. The scope of the invention is defined by the appended claims rather than the description of the above embodiments. The scope of the invention is intended to encompass all modifications within the scope of the appended claims and equivalents thereof.

1. A hybrid vehicle comprising:
an internal combustion engine including a variable valve actuating device that is configured to change an operation characteristic of an intake valve to one of a first characteristic and a second characteristic, at least one of a valve lift or valve operating angle of the intake valve at the time when the operation characteristic is the second characteristic is larger than the corresponding at least one of the valve lift or valve operating angle of the intake valve at the time when the operation characteristic is the first characteristic;
an electric motor configured to be used to start up the internal combustion engine;
an electrical storage device configured to store electric power for driving the electric motor; and
a controller configured to control an output from the electrical storage device based on a state of the electrical storage device such that the output from the electrical storage device at the time when start-up of the internal combustion engine is required in a predetermined condition in a state where the operation characteristic is set to the second characteristic is higher than the output from the electrical storage device, which is set based on the state of the electrical storage device at the time when start-up of the internal combustion engine is required, the predetermined condition being a condition in which startability of the internal combustion engine deteriorates.

2. The hybrid vehicle according to claim 1, wherein the controller is configured to:
control the output from the electrical storage device such that the output from the electrical storage device decreases as an SOC of the electrical storage device decreases;
control the SOC such that the SOC is higher than a control lower limit of the SOC;
when the predetermined condition is satisfied in the state where the operation characteristic is set to the second characteristic at the time when a process of stopping the internal combustion engine is executed, increase the SOC of the electrical storage device by increasing the control lower limit such that the output from the electrical storage device is higher than the output from the electrical storage device, which is set based on the SOC at the time when the predetermined condition is satisfied; and
stop the internal combustion engine after the SOC is increased to above the control lower limit.

3. The hybrid vehicle according to claim 1, wherein the controller is configured to:
limit the output from the electrical storage device based on a decrease in a temperature of the electrical storage device; and
when the internal combustion engine is in a cold state in the state where the operation characteristic is set to the second characteristic and when start-up of the internal combustion engine is required, set a discharge power upper limit value of the electrical storage device such that the discharge power upper limit value is higher than the discharge power upper limit value that is set based on the temperature of the electrical storage device at the time when start-up of the internal combustion engine is required.

4. The hybrid vehicle according to claim 3, wherein
the controller is configured to, at the time when a process of starting up the internal combustion engine is executed, execute a process of increasing the discharge power upper limit value.

5. The hybrid vehicle according to claim 1, wherein
the controller is configured to, when the variable valve actuating device is inoperable in the state where the operation characteristic is set to the second characteristic, execute a process of increasing the output from the electrical storage device.

6. The hybrid vehicle according to claim 1, wherein
the variable valve actuating device is configured to change the operation characteristic to one of the first characteristic and the second characteristic stepwisely.

7. The hybrid vehicle according to claim 6, wherein
the variable valve actuating device is configured to change the operation characteristic to a third characteristic, at least one of the valve lift or the valve operating angle at the time when the operation characteristic is the third characteristic is larger than the corresponding at least one of the valve lift or the valve operating angle at the time when the operation characteristic is the first characteristic, and at least one of the valve lift or the valve operating angle at the time when the operation characteristic is the third characteristic is smaller than the corresponding at least one of the valve lift or the valve operating angle at the time when the operation characteristic is the second characteristic.

8. A control device for a hybrid vehicle, the hybrid vehicle including an internal combustion engine, an electric motor and an electrical storage device, the internal combustion engine including a variable valve actuating device, the electric motor being configured to be used to start up the internal combustion engine, the electrical storage device being configured to store electric power for driving the electric motor, the control device comprising:
a controller configured to
control the variable valve actuating device such that an operation characteristic of an intake valve is changed to one of a first characteristic and a second characteristic, at least one of a valve lift or valve operating angle of the intake valve at the time when the operation characteristic is the second characteristic being larger than the corresponding at least one of the valve lift or valve operating angle of the intake valve at the time when the operation characteristic is the first characteristic; and
control an output from the electrical storage device based on a state of the electrical storage device such that the output from the electrical storage device at the time when start-up of the internal combustion engine is required in a predetermined condition in a state where the operation characteristic is set to the second characteristic is higher than the output from the electrical storage device, which is set based on the state of the electrical storage device at the time when start-up of the internal combustion engine is required, the predetermined condition being a condition in which startability of the internal combustion engine deteriorates.

9. A control method for a hybrid vehicle, the hybrid vehicle including an internal combustion engine, an electric motor, an electrical storage device and a controller, the internal combustion engine including a variable valve actuating device, the electric motor being configured to be used to start up the internal combustion engine, the electrical storage device being configured to store electric power for driving the electric motor, the control method comprising:
controlling, by the controller, the variable valve actuating device such that an operation characteristic of an intake valve is changed to one of a first characteristic and a second characteristic, at least one of a valve lift or valve operating angle of the intake valve at the time when the operation characteristic is the second characteristic being larger than the corresponding at least one of the valve lift or valve operating angle of the intake valve at the time when the operation characteristic is the first characteristic; and
controlling, by the controller, an output from the electrical storage device based on a state of the electrical storage device such that the output from the electrical storage device at the time when start-up of the internal combustion engine is required in a predetermined condition in a state where the operation characteristic is set to the second characteristic is higher than the output from the electrical storage device, which is set based on the state of the electrical storage device at the time when start-up of the internal combustion engine is required, the predetermined condition being a condition in which startability of the internal combustion engine deteriorates.
